(19) United States
(12) Patent Application Publication
(10) Pub. No.: US 2016/0012038 A1
(43) Pub. Date: Jan. 14, 2016

(54) SEMANTIC TYPING WITH N-GRAM ANALYSIS

(71) Applicant: International Business Machines Corporation, Armonk, NY (US)

(72) Inventors: Stephen J. Edwards, Longmont, CO (US); Barton W. Emanuel, Manassas, VA (US); Daniel J. McCloskey, Dublin (IE); Craig M. Trim, Sylmar, CA (US)

(21) Appl. No.: 14/327,645

(22) Filed: Jul. 10, 2014

(51) Int. Cl. G06F 17/27

(52) U.S. Cl. CPC G06F 17/2785

(57) ABSTRACT

Natural language processing is provided. A unigram of a portion of text is determined, wherein the portion of text comprises a plurality of words. An initial confidence level of the unigram is determined, wherein the initial confidence level represents a probability that the unigram is of a semantic type identified by the initial confidence level. An expanded n-gram of the portion of text is determined, based, at least in part, on the unigram. Semantic analysis is performed on the expanded n-gram. At least one part of speech of the expanded n-gram is identified. Based, at least in part, on the initial confidence level, the semantic analysis, and the at least one part of speech, an adjusted confidence level of the expanded n-gram is determined.

### BACKGROUND OF THE INVENTION

The present invention relates generally to the field of natural language processing, and more particularly to semantic typing with n-gram analysis.

Tokenization is the process of breaking a stream of text into words, phrases, symbols, or other meaningful elements called tokens. The list of tokens becomes input for further processing such as parsing or text mining. Tokenization is useful both in linguistics (where it is a form of text segmentation), and in computer science, where it forms part of lexical analysis.

In the fields of computational linguistics and probability, an n-gram is a contiguous sequence of n items from a given sequence of text or speech. The items can be phonemes, syllables, letters, words or base pairs, according to the application. The n-grams typically are collected from a text or speech corpus. An n-gram of size one (i.e., having one item) is referred to as a “unigram”; size two is a “bigram”; size three is a “trigram”. Larger sizes are sometimes referred to by the value of n, for example, “four-gram”, “five-gram”, and so on.

### SUMMARY

According to one embodiment of the present disclosure, a method for natural language processing is provided. The method includes determining a unigram of a portion of text, wherein the portion of text comprises a plurality of words; determining an initial confidence level of the unigram, wherein the initial confidence level represents a probability that the unigram is of a semantic type identified by the initial confidence level; determining an expanded n-gram of the portion of text based, at least in part, on the unigram; performing semantic analysis on the expanded n-gram; identifying at least one part of speech of the expanded n-gram; and determining, based, at least in part, on the initial confidence level, the semantic analysis, and the at least one part of speech, an adjusted confidence level of the expanded n-gram.

According to another embodiment of the present disclosure, a computer program product for natural language processing is provided. The computer program product comprising a computer readable storage medium and program instructions stored on the computer readable storage medium. The program instructions include program instructions to determine a unigram of a portion of text, wherein the portion of text comprises a plurality of words; program instructions to determine an initial confidence level of the unigram, wherein the initial confidence level represents a probability that the unigram is of a semantic type identified by the initial confidence level; program instructions to determine an expanded n-gram of the portion of text based, at least in part, on the unigram; program instructions to perform semantic analysis on the expanded n-gram; program instructions to identify at least one part of speech of the expanded n-gram; and program instructions to determine, based, at least in part, on the initial confidence level, the semantic analysis, and the at least one part of speech, an adjusted confidence level of the expanded n-gram.

According to another embodiment of the present disclosure, a computer for natural language processing is provided. The computer system includes one or more computer processors, one or more computer readable storage media, and program instructions stored on the computer readable storage media for execution by at least one of the one or more processors. The program instructions include program instructions to determine a unigram of a portion of text, wherein the portion of text comprises a plurality of words; program instructions to determine an initial confidence level of the unigram, wherein the initial confidence level represents a probability that the unigram is of a semantic type identified by the initial confidence level; program instructions to determine an expanded n-gram of the portion of text based, at least in part, on the unigram; program instructions to perform semantic analysis on the expanded n-gram; program instructions to identify at least one part of speech of the expanded n-gram; and program instructions to determine, based, at least in part, on the initial confidence level, the semantic analysis, and the at least one part of speech, an adjusted confidence level of the expanded n-gram.

### BRIEF DESCRIPTION OF THE DRAWINGS

FIG. 1 is a functional block diagram illustrating a computing environment, in accordance with an embodiment of the present disclosure;

FIG. 2 is a flowchart depicting operations for natural language processing, on a computing device within the computing environment of FIG. 1, in accordance with an embodiment of the present disclosure; and

FIG. 3 is a block diagram of components of a computing device executing operations for natural language processing, in accordance with an embodiment of the present disclosure.

### DETAILED DESCRIPTION

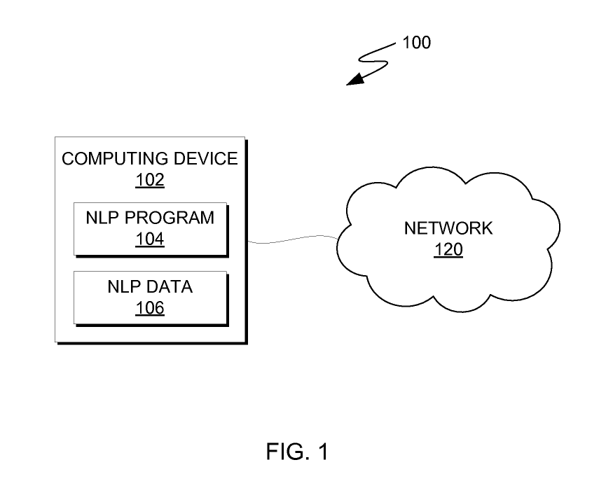

The present disclosure will now be described in detail with reference to the Figures. FIG. 1 is a functional block diagram illustrating a computing environment, in accordance with an embodiment of the present disclosure. For example, FIG. 1 is a functional block diagram illustrating computing environment 100. Computing environment 100 includes computing device 102 to network 120. Computing device 102 includes natural language processing (NLP) program 104 and NLP data 106.

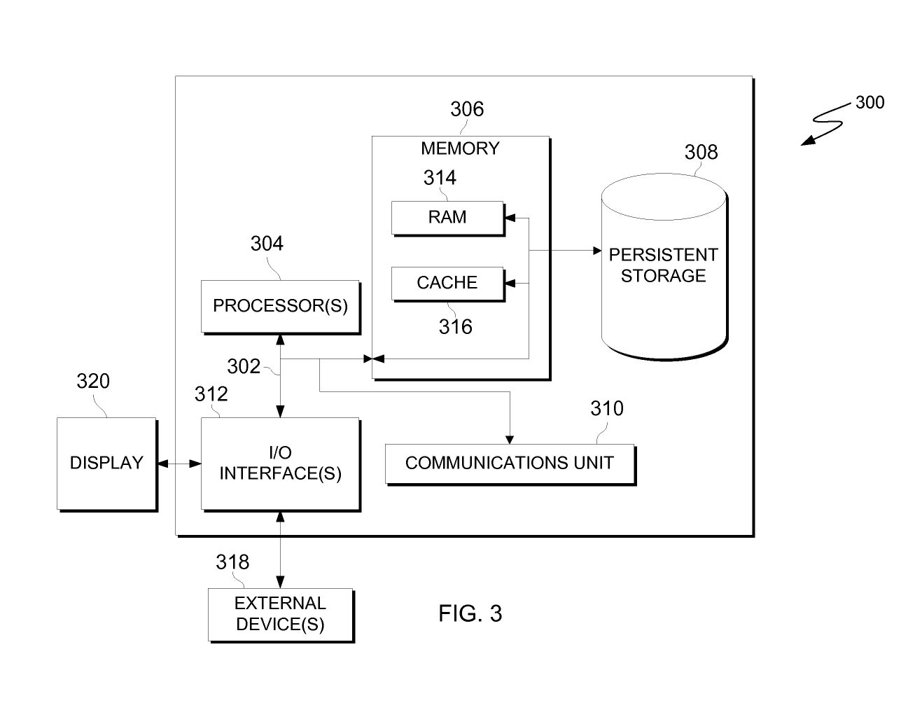

In various embodiments of the present invention, computing device 102 is a computing device that can be a standalone device, a server, a laptop computer, a tablet computer, a netbook computer, a personal computer (PC), or a desktop computer. In another embodiment, computing device 102 represents a computing system utilizing clustered computers and components to act as a single pool of seamless resources. In general, computing device 102 can be any computing device or a combination of devices with access to and/or capable of executing NLP program 104 and NLP data 106. Computing device 102 may include internal and external hardware components, as depicted and described in further detail with respect to FIG. 3.

In this example embodiment, NLP program 104 and NLP data 106 are stored on computing device 102. In other embodiments, one or both of NLP program 104 and NLP data 106 may reside on another computing device, provided that each can access and is accessible by the other. In yet other embodiments, one or both of NLP program 104 and NLP data 106 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications with computing device 102, in accordance with a desired embodiment of the present invention.

NLP program 104 operates to perform natural language processing including semantic typing with n-gram analysis. NLP program 104 performs token matching on a portion of text. NLP program 104 perform n-gram analysis, which includes determining a confidence level. If the confidence level exceeds a threshold, NLP program 104 applies a semantic type to the n-gram.

NLP data 106 is a data repository that may be written to and read by NLP program 104. One or both of token information and n-gram information may be stored to NLP data 106. In some embodiments, NLP data 106 may be written to and read by programs and entities outside of computing environment 100 in order to populate the repository with token information, n-gram information, or both. The token information identifies one or more tokens. The n-gram information identifies one or more n-grams. Each n-gram is associated with n-gram details, which include information describing each n-gram. Each n-gram includes one or more tokens. In one embodiment, an n-gram can include another n-gram. For example, the bigram “the bucket” includes the unigram “bucket”. Conversely, in this example, the unigram “bucket” includes no other n-grams.

In some embodiments, the n-gram details of an n-gram include one or more semantic types. The semantic type disambiguates usages of the same n-gram. For example, the unigram “trouble” can be used as a negation, as in the sentence “I'm having trouble with my internet connection.” Alternatively, the unigram “trouble” can be used as a predicate, as in the sentence, “The connection speed troubles me.” In some embodiments, each semantic type of an n-gram is associated with a confidence level. In one embodiment, the confidence level of a semantic type represents the likelihood that an n-gram is of the semantic type. For example, for the unigram “trouble”, the negation confidence level is higher than the predicate confidence level. In this case, the higher confidence level for the semantic type “negation” compared to “predicate” reflects a higher probability that the word “trouble” is used as a negation rather than as a predicate. Similarly, for the semantic type “negation”, the higher confidence level for the bigram “having trouble” compared to the bigram “no trouble” reflects a higher probability that the phrase “having trouble”, rather than the phrase “no trouble”, is used as a negation.

In some embodiments, the n-gram details of an n-gram include one or more parts of speech for each token of the n-gram. In one embodiment, each semantic type of a token is associated with a part of speech. For example, the part of speech of a token may be used as a noun, verb, adjective, or adverb.

In one example, NLP data 106 identifies “trouble” as an n-gram with one token (i.e., a unigram). The unigram has semantic types including “negation” and “predicate”, each with a confidence level, as discussed above. The unigram “trouble” is associated with one or more other n-grams. In this example, the other n-grams: unigrams including “trouble”; bigrams including “trouble with”, “have trouble”, “trouble using”, and “having trouble”; and trigrams including “having trouble with”, “having trouble using”, and “have trouble with”. In this example, each of the n-grams has a 50% confidence level, representative of a 50% chance that the word “trouble” is used in the sense of the semantic type (“negation”). In other examples, the unigram “trouble” is also associated with n-grams having a lower confidence level for the semantic type negation, such as the bigram “no trouble” and the trigram “not having trouble”.

In some embodiments, each token of NLP data 106 is associated with token details, which include information describing the token for one or more domains of natural language. A domain provides a context in which the meaning and usage of text is interpreted. For example, in the context of a zoology domain, the word “crane” is likely to refer to a type of bird. Conversely, in the context of a construction domain, the word “crane” is likely to refer to a device for lifting and moving heavy weights in suspension. As another example, in the context of an oil and gas domain, the word “well” is likely to refer to an oil well. However, the word “well” can also be used as an interjection, as in the sentence: “Well, I don't have any trouble.” Similarly, in some embodiments, NLP data 106 includes n-gram details for each n-gram describing the n-gram for one or more domains of natural language.

In an example embodiment, NLP data 106 includes n-gram details for the token “trouble” such as the following:

:TROUBLE

rdf:type :Negation ;
rdfs:bigram “trouble with”@us , “have trouble”@us ,

“trouble using”@us , “having trouble”@us ;

rdfs:label “Trouble”@us ;
rdfs:trigram “having trouble with”@us , “having trouble using”@us ,

“have trouble with”@us ;

| | |
|---|---|
| | rdfs:unigram “trouble”@us . |
| [ ] | rdf:type rdf:Statement ; |
| | rdf:object “trouble”@us ; |
| | rdf:predicate rdfs:unigram ; |
| | rdf:subject :TROUBLE ; |
| | rdfs:confidence “50”\hat{ }\hat{ }xsd:string . |
| [ ] | rdf:type rdf:Statement ; |
| | rdf:object “having trouble”@us ; |
| | rdf:predicate rdfs:bigram ; |
| | rdf:subject :TROUBLE ; |
| | rdfs:confidence “60”\hat{ }\hat{ }xsd:string . |

The above example shows unigrams, bigrams, and trigrams. However, in other embodiments and examples, the size of the n-grams can be arbitrarily large.

In another example embodiment, NLP data 106 includes n-gram details for the token “well” such as the following:

| WELL | |
|---|---|
| | rdf:type :Negation ; |
| | rdfs:hasPartOfSpeech |
| | EngGrammar:Noun ; |
| | rdfs:unigram “Well”@us . |
| [ ] | rdf:type rdf:Statement ; |
| | rdf:object EngGrammar:Noun ; |
| | rdf:predicate rdfs:hasPartOfSpeech ; |
| | rdf:subject :WELL ; |
| | rdfs:confidence “100”\hat{ }\hat{ }xsd:string . |

The above example shows that, if the token “well” is used as a noun, then the confidence level for that part of speech is one hundred percent. Conversely, in another example, the above example n-gram details for the token “well” additionally indicate a fifty-one percent confidence level if the token is used as an adjective.

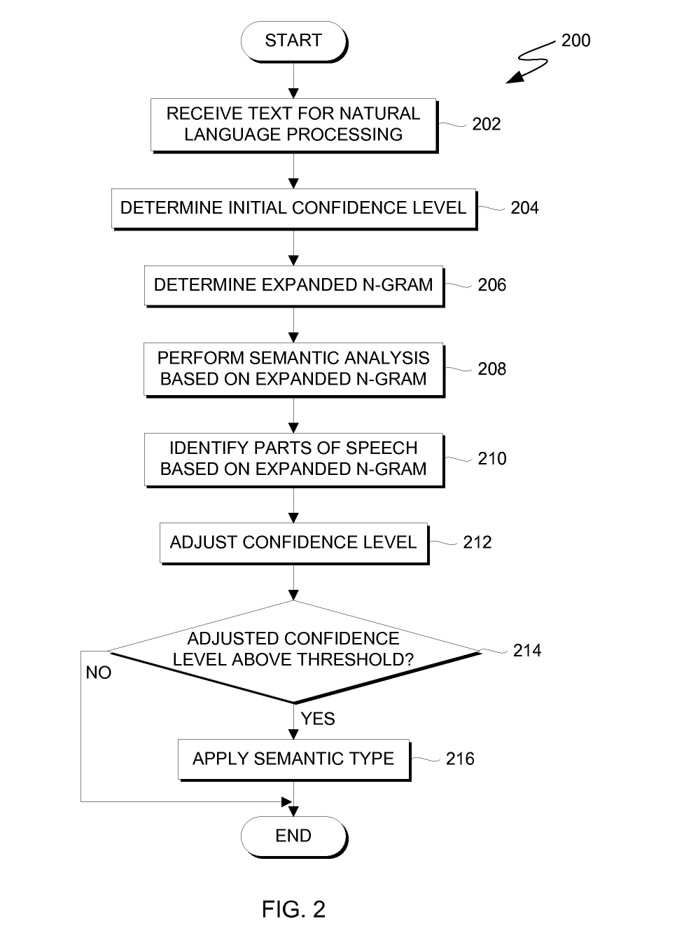

FIG. 2 is a flowchart depicting operations for natural language processing, on a computing device within the computing environment of FIG. 1, in accordance with an embodiment of the present disclosure. For example, FIG. 2 is a flowchart depicting operations 200 of NLP program 104, on computing device 102 within computing environment 100.

In operation 202, NLP program 104 receives text for natural language processing. In one embodiment, NLP program 104 receives a stream of text. In one embodiment, NLP program 104 receives the stream of text via network 120. For example, the stream of text may be user input received by a client device (not shown) and sent to computing device 102 via network 120. In such embodiments, NLP program 104 may perform operations 200 in real-time. That is, NLP program 104 may perform natural language processing on the stream of text as the stream of text is received. In another embodiment, NLP program 104 receives the text from a database or data repository (e.g., NLP data 106). In one example, NLP program 104 receives the text “Well, I don't have any trouble.” In one embodiment, NLP program 104 performs various natural language processing techniques on the received text. For example, NLP program 104 performs tokenization to identify one or more tokens of the received text, such as the word “trouble” in the previous example text. In one embodiment, NLP program 104 determines a unigram based at least on the received text. As in the previous example, NLP program 104 compares the identified token “trouble” to data identifying unigrams of NLP data 106 to determine that “trouble” is a unigram.

In operation 204, NLP program 104 determines an initial confidence level. As described previously, in one embodiment, the confidence level of a semantic type represents the likelihood that an n-gram is of the semantic type. In one embodiment, NLP program 104 determines the initial confidence level by determining a unigram of the received text (see operation 202) and determining the initial confidence level based on the unigram. For example, the initial confidence level represents a probability that the unigram is of a determined semantic type. In one embodiment, NLP program 104 determines the initial confidence level based on an initial determination of a semantic type of the unigram. In various embodiments, NLP program 104 determines the semantic type of the unigram utilizing one or more of various NLP methods for semantic typing. For example, NLP program 104 determines the semantic type of the unigram by retrieving information indicating one or more possible semantic types from NLP data 106 and determining which of the one or more possible semantic types is the most common semantic type for the unigram. In one embodiment, the initial determination of the semantic type of the unigram is a Boolean determination that yields an initial confidence level of either 0% or 100%. In one example, NLP program 104 determines an initial confidence level of 100% that the unigram “trouble” is a negation semantic type.

In operation 206, NLP program 104 determines an expanded n-gram. In various embodiments, the expanded n-gram is a bigram, a trigram, or other n-gram. In one embodiment, NLP program 104 determines an expanded n-gram based on NLP data 106, the received text (see operation 202), and the unigram (see operation 204) of the text. For example, NLP program 104 determines the expanded n-gram by identifying the longest n-gram included in NLP data 106 that includes the unigram. In one embodiment, NLP program 104 identifies one or more n-grams of NLP data 106 that include the unigram (see operation 204). In this case, NLP program 104 compares each of the identified one or more n-grams to the received text (see operation 202) and determines the expanded n-gram to be the longest n-gram of the identified one or more n-grams that is both included in the received text and that contains the unigram.

In some embodiments, NLP program 104 determines the expanded n-gram utilizing pattern matching. For example, the text “don't have any trouble” is not an exact match for the trigram “don't have trouble”, but the semantic value is equivalent. Thus, NLP program 104, in this embodiment, uses a pattern that includes a wildcard, which is a portion of the pattern (e.g., a token) that represents a set of tokens with do not modify the meaning of the rest of the phrase in which the wildcard is included. In one embodiment, NLP data 106 includes such patterns in the n-gram details. For example, the n-gram details for the trigram “don't have trouble” include the pattern “don't have {wildcard} trouble”. In this case, the n-gram details identify “{wildcard}” as representing the token “any” or no token. In this example, NLP program 104 compares the text “don't have any trouble” to the pattern “don't have {wildcard} trouble” to determine that “don't have any trouble” matches the trigram “don't have trouble”, despite having four tokens. Similarly, such a pattern can include, in some embodiments, one or more variations of tokens within an n-gram. For example, “do not” is a variant of “don't”. As another example, “problems” is a variant of “trouble”. In other embodiments, NLP program 104 determines variants of the n-grams of NLP data 106. NLP program 104 determines variants of an n-gram utilizing any of various techniques, including those that perform transformations based on morphological, syntactic, or semantic variations. Thus, NLP program 104 may determine that the n-gram “don't have {token} trouble” matches the text segments “don't have any trouble”, “don't have problems”, and “do not have any trouble”.

In some embodiments, NLP program 104 determines an expanded n-gram based, at least in part, on a threshold, which represents a minimum confidence level. In various embodiments, the threshold is pre-determined, algorithmically determined, or determined based on user input. Each n-gram of NLP data 106 has an associated confidence level. In one embodiment, NLP program 104 identifies one or more n-grams of NLP data 106 that include the unigram (see operation 204), wherein each of the one or more n-grams has n-gram details including a confidence level representing a probability that the n-gram is of the initially determined semantic type (see operation 204). In this case, NLP program 104 compares each of the identified one or more n-grams to the received text (see operation 202) and determines the expanded n-gram to be the longest n-gram of the identified one or more n-grams that is included in the received text, that contains the unigram, and that has a confidence level above the threshold.

In operation 208, NLP program 104 performs semantic analysis based on the expanded n-gram. In one embodiment, performing semantic analysis includes grouping words of the expanded n-gram based on the semantic content of the words. For example, NLP program 104 performs semantic analysis on the expanded n-gram “setup is completely finished” to group “completely” and “finished” based on the semantic content of each. In this example, NLP program 104 groups the words “completely” and “finished” based on the words being redundant of one another. In another embodiment, performing semantic analysis includes identifying words of the expanded n-gram that represent a single part of speech (e.g., compound nouns). For example, NLP program 104 performs semantic analysis to identify “swimming pool” as a compound noun in the expanded n-gram “the swimming pool is open”. In another embodiment, performing semantic analysis includes determining the relationships between words of the expanded n-gram. For example, NLP program 104 performs semantic analysis on the expanded n-gram “trouble with the computer” by determining that “with the computer” is a phrase modifying the word “trouble”.

In operation 210, NLP program 104 identifies parts of speech based on the expanded n-gram. In one embodiment, NLP program 104 identifies a part of speech of each token (e.g., each word or phrase) of the expanded n-gram. More than one part of speech may be identified for each token. The identification of each part of speech has an associated confidence level. For example, NLP program 104 identifies parts of speech for the expanded n-gram “distance learning”, which is a bigram. The word “distance” as an adjective has a 50% confidence level, “learning” as a noun has a 50% confidence level, and “distance learning” as a compound noun has a 90% confidence level. In one embodiment, NLP program 104 identifies the part of speech of each word or phrase of the expanded n-gram based on the part of speech for the word or phrase with the highest associated confidence level. Thus, in the previous example, NLP program 104 identifies “distance learning” as a compound noun. In some embodiments, NLP program 104 identifies parts of speech for the expanded n-gram utilizing one or more parsers, databases, references, or other systems. For example, NLP program 104 can use deep parsers, such as Apache™ OpenNLP™ or English slot grammar (ESG), to identify the part of speech of a word or token. (Apache and OpenNLP are trademarks of The Apache Software Foundation.)

In operation 212, NLP program 104 adjusts the confidence level of the expanded n-gram. In one embodiment, NLP program 104 adjusts the confidence level based on the semantic analysis and the identified parts of speech of the expanded n-gram. In one embodiment, NLP program 104 adjusts the confidence level of an expanded n-gram by combining (e.g., by an average or by a weighted average) the confidence level associated with the identification of the part of speech of each token of the expanded n-gram (see operation 210) with the confidence level of the expanded n-gram from NLP data 106 (see operation 206).

In decision 214, NLP program 104 determines whether the adjusted confidence level exceeds a threshold. In various embodiments, the threshold is pre-determined, received as user input, or generated by NLP program 104. For example, the threshold may be 50%. If NLP program 104 determines that the adjusted confidence level exceeds the threshold (decision 214, YES branch), then NLP program 104 applies the semantic type to the expanded n-gram (operation 216). If NLP program 104 determines that the adjusted confidence level does not exceed the threshold (decision 214, NO branch), then operations 200 of NLP program 104 are concluded.

In operation 216, NLP program 104 applies the semantic type to the expanded n-gram. In one embodiment, NLP program 104 applies a semantic type to the expanded n-gram by labeling the expanded n-gram with a semantic type and an adjusted confidence level. In another embodiment, NLP program 104 also labels the expanded n-gram with one or more parts of speech. In various embodiments, NLP program 104 labels an expanded n-gram (e.g., with a semantic type, part of speech, or adjusted confidence level) by storing an association between the expanded n-gram and the label to NLP data 106, by providing the label via a user interface, or by modifying the expanded n-gram to indicate the label.

For example, NLP program 104 receives the text “Well, I don't have any trouble.” NLP program 104 determines expanded n-grams including “well” and “don't have any trouble”. For the n-gram “well”, NLP program 104 determines a part of speech (e.g., interjection for the token “well”), a semantic type (e.g., statement), and an adjusted confidence level (e.g., 51%). Based on the adjusted confidence level exceeding a threshold (e.g., 50%), NLP program 104 applies the semantic type to the n-gram. Similarly, for the n-gram “don't have any trouble”, NLP program 104 determines a part of speech for each token (e.g., noun for the token “trouble”), a semantic type (e.g., negation), and an adjusted confidence level (e.g., 0%). Based on the adjusted confidence level failing to exceed a threshold (e.g., 50%), NLP program 104 withholds applying the semantic type to the expanded n-gram.

FIG. 3 is a block diagram, generally designated 300, of components of the computing device executing operations for natural language processing, in accordance with an embodiment of the present disclosure. For example, FIG. 3 is a block diagram of computing device 102 within computing environment 100 executing operations of NLP program 104.

It should be appreciated that FIG. 3 provides only an illustration of one implementation and does not imply any limitations with regard to the environments in which different embodiments may be implemented. Many modifications to the depicted environment may be made.

Computing device 102 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Each of NLP program 104 and NLP data 106 is stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of network 120. In these examples, communications unit 310 includes one or more network interface cards. Communications unit 310 may provide communications through the use of either or both physical and wireless communications links. Each of NLP program 104 and NLP data 106 may be downloaded to persistent storage 308 through communications unit 310.

I/O interface(s) 312 allows for input and output of data with other devices that may be connected to computing device 102. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention (e.g., NLP program 104 and NLP data 106) can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for natural language processing, the method comprising:
determining, by one or more processors, a unigram of a portion of text, wherein the portion of text comprises a plurality of words;
determining, by the one or more processors, an initial confidence level of the unigram, wherein the initial confidence level represents a probability that the unigram is of a semantic type identified by the initial confidence level;
determining, by the one or more processors, an expanded n-gram of the portion of text based, at least in part, on the unigram;
performing, by the one or more processors, semantic analysis on the expanded n-gram;
identifying, by the one or more processors, at least one part of speech of the expanded n-gram; and
determining, by the one or more processors, based, at least in part, on the initial confidence level, the semantic analysis, and the at least one part of speech, an adjusted confidence level of the expanded n-gram.

2. The method of claim 1, further comprising:
responsive to determining that the adjusted confidence level exceeds a pre-determined threshold, associating, by the one or more processors, the expanded n-gram with a semantic type, wherein the semantic type indicates a usage of the expanded n-gram.

3. The method of claim 1, wherein determining the expanded n-gram comprises:
determining, by the one or more processors, an n-gram that includes a first token, wherein the first token is a token of the unigram.

4. The method of claim 1, wherein determining the initial confidence level comprises:
determining, by the one or more processors, a semantic type of the unigram, wherein the semantic type indicates a usage of the unigram.

5. The method of claim 1, wherein determining the expanded n-gram comprises:
identifying, by the one or more processors, one or more words of the portion of text that correspond to a pattern of the expanded n-gram, wherein the pattern includes a first token that represents a set of tokens, wherein the one or more words of the portion of text correspond to the pattern of the expanded n-gram by substituting at least one of the set of tokens in place of the first token.

6. The method of claim 1, wherein performing semantic analysis on the expanded n-gram comprises grouping, by the one or more processors, one or more words of the expanded n-gram based on a semantic content of the one or more words.

7. The method of claim 2, further comprising:
providing, by the one or more processors, the expanded n-gram, the semantic type, the at least one part of speech, and the adjusted confidence level via a user interface.

8. A computer program product for natural language processing, the computer program product comprising:
a computer readable storage medium and program instructions stored on the computer readable storage medium, the program instructions comprising:
program instructions to determine a unigram of a portion of text, wherein the portion of text comprises a plurality of words;
program instructions to determine an initial confidence level of the unigram, wherein the initial confidence level represents a probability that the unigram is of a semantic type identified by the initial confidence level;
program instructions to determine an expanded n-gram of the portion of text based, at least in part, on the unigram;
program instructions to perform semantic analysis on the expanded n-gram;
program instructions to identify at least one part of speech of the expanded n-gram; and
program instructions to determine, based, at least in part, on the initial confidence level, the semantic analysis, and the at least one part of speech, an adjusted confidence level of the expanded n-gram.

9. The computer program product of claim 8, wherein the program instructions further comprise program instructions to responsive to determining that the adjusted confidence level exceeds a pre-determined threshold, associate the expanded n-gram with a semantic type, wherein the semantic type indicates a usage of the expanded n-gram.

10. The computer program product of claim 8, wherein the program instructions to determine the expanded n-gram comprise program instructions to determine an n-gram that includes a first token, wherein the first token is a token of the unigram.

11. The computer program product of claim 8, wherein the program instructions to determine the initial confidence level comprise program instructions to determine a semantic type of the unigram, wherein the semantic type indicates a usage of the unigram.

12. The computer program product of claim 8, wherein the program instructions to determine the expanded n-gram comprise program instructions to identify one or more words of the portion of text that correspond to a pattern of the expanded n-gram, wherein the pattern includes a first token that represents a set of tokens, wherein the one or more words of the portion of text correspond to the pattern of the expanded n-gram by substituting at least one of the set of tokens in place of the first token.

13. The computer program product of claim 8, wherein the program instructions to perform semantic analysis on the expanded n-gram comprise program instructions to group, by the one or more processors, one or more words of the expanded n-gram based on a semantic content of the one or more words.

14. A computer system for natural language processing, the computer system comprising:
one or more computer processors;
one or more computer readable storage media;
program instructions stored on the computer readable storage media for execution by at least one of the one or more computer processors, the program instructions comprising:
program instructions to determine a unigram of a portion of text, wherein the portion of text comprises a plurality of words;
program instructions to determine an initial confidence level of the unigram wherein the initial confidence level represents a probability that the unigram is of a semantic type identified by the initial confidence level;
program instructions to determine an expanded n-gram of the portion of text based, at least in part, on the unigram;
program instructions to perform semantic analysis on the expanded n-gram;
program instructions to identify at least one part of speech of the expanded n-gram; and
program instructions to based, at least in part, on the initial confidence level, the semantic analysis, and the at least one part of speech, an adjusted confidence level of the expanded n-gram.

15. The computer system of claim 14, wherein the program instructions further comprise program instructions to responsive to determining that the adjusted confidence level exceeds a pre-determined threshold, associate the expanded n-gram with a semantic type, wherein the semantic type indicates a usage of the expanded n-gram.

16. The computer system of claim 14, wherein the program instructions to determine the expanded n-gram comprise program instructions to determine an n-gram that includes a first token, wherein the first token is a token of the unigram.

17. The computer system of claim 14, wherein the program instructions to determine the initial confidence level comprise program instructions to determine a semantic type of the unigram, wherein the semantic type indicates a usage of the unigram.

18. The computer system of claim 14, wherein the program instructions to determine the expanded n-gram comprise program instructions to identify one or more words of the portion of text that correspond to a pattern of the expanded n-gram, wherein the pattern includes a first token that represents a set of tokens, wherein the one or more words of the portion of text correspond to the pattern of the expanded n-gram by substituting at least one of the set of tokens in place of the first token.

19. The computer system of claim 14, wherein the program instructions to perform semantic analysis on the expanded n-gram comprise program instructions to group, by the one or more processors, one or more words of the expanded n-gram based on a semantic content of the one or more words.
